(19) United States
(12) Patent Application Publication
(10) Pub. No.: US 2026/0208965 A1
(43) Pub. Date: Jul. 23, 2026

(54) DISC SPREADER WITH A DISCHARGE SHAFT

(71) Applicant: Rauch Landmaschinenfabrik GmbH, Rheinmuenster (DE)

(72) Inventors: Jean-Baptiste VALENTIN, Strasbourg (FR); Marius KNOPF, Ottersweier-Unzhurst (DE)

(73) Assignee: RAUCH Landmaschinenfabrik GmbH, Rheinmuenster (DE)

(21) Appl. No.: 19/453,972

(22) Filed: Jan. 20, 2026

(30) Foreign Application Priority Data
Jan. 20, 2025 (DE) 20 2025 100 275.2

(51) Int. Cl. B65G 31/04; A01C 17/00

(52) U.S. Cl. CPC B65G 31/04; A01C 17/001; A01C 17/008

(57) ABSTRACT

A disc spreader for distributing distributed material is proposed, comprising a supply container for accommodating the distributed material, with a discharge opening, a dosing element, downstream from the discharge opening of the supply container, having a dosing opening, and a spreader disc that is situated below the dosing opening and rotatable about a rotational axis. A discharge shaft that encloses at least a circumferential section of the dosing opening extends downwardly from the dosing opening in the direction of the spreader disc to protect the falling distributed material from external influences. The invention provides that the discharge shaft at its free end facing the spreader disc extends essentially completely around the dosing opening, with the discharge shaft having a passage, used for pressure compensation, in the area of its end facing away from the spreader disc.

This nonprovisional application claims priority under 35 U.S.C. §119(a) to German Patent Application No. 20 2025 100 275.2, which was filed in Germany on Jan. 20, 2025, and which is herein incorporated by reference.

### BACKGROUND OF THE INVENTION

### Field of the Invention

The invention relates to a disc spreader for distributing distributed material, comprising a supply container for accommodating the distributed material, with at least one discharge opening, at least one dosing element, downstream from the discharge opening of the supply container, having a dosing opening, and at least one spreader disc that is situated below the dosing opening and rotatable about a rotational axis, wherein a discharge shaft that encloses at least a circumferential section of the dosing opening extends downwardly from the dosing opening in the direction of the spreader disc.

### Description of the Background Art

Disc spreaders or disc broadcasters in the form of agricultural machines for applying powdered or particulate distributed material, in particular fertilizer or seed, are known in various designs, for example in a pulled design as a self-propelled unit, or accommodated by a three-point hitch of a towing machine such as a tractor. They include a supply container that holds the distributed material to be applied, with typically one or two discharge openings situated at the underside thereof, and with one dosing element, each having a dosing opening in flush alignment at least with a section of the discharge opening, being associated with the respective discharge opening in order to remove the distributed material from the supply container in the desired quantity, or more precisely, with the desired mass flow. The dosing element, which is usually positioned beneath the discharge opening, is controllably openable and closeable, either manually or in particular via actuator, for example by means of actuating cylinders, servomotors, or the like, to allow the desired mass flow to be adjusted, depending on the desired quantity of distributed material per unit area, the desired distribution width of the distributed material to be applied to the ground, the travel speed, and the physical properties of the distributed material such as its flowability. The spreader disc, which generally is equipped with ejector vanes or blades, is situated below the dosing opening of the dosing element, and distributes the distributed material across the desired working width and is rotatable about a typically approximately vertical rotational axis, whether by connection of a drive train of the spreader disc to the power take-off shaft of a towing machine such as a tractor, or via the spreader disc's own drive, such as a hydraulic motor, electric motor, or the like.

In addition, present disc spreaders are equipped with an apparatus for adjusting the point of application of the distributed material onto the spreader disc, with the point of application being adjustable with respect to the distribution element radially (in particular to increase/decrease the spread fan) and/or circumferentially (in particular to rotate the spread fan about the rotational axis of the distribution element, for example). The apparatus for adjusting the point of application has either one or multiple handles for manually adjusting the point of application, or one or multiple actuators which may likewise include actuating cylinders, servomotors, or the like and which are designed to move the dosing opening of the dosing element back and forth relative to the spreader disc, and in special cases also relative to the discharge opening, which generally is situated stationarily with respect to the container, wherein this back-and-forth movement, as indicated above, may be a translational and/or a rotational movement. For automatic machines, the control or regulation of the actuator of the apparatus for adjusting the point of application as a function of the desired distribution width takes over a programmably configured control and/or regulation device of the disc spreader that is generally in operative connection with at least one control module, which may be situated, for example, in the driver's cab of a towing machine such as a tractor. The same generally applies for the control or regulation of the dosing element as a function of the desired mass flow of the distributed material to be applied. If the disc spreader has no apparatus for adjusting the point of application, the discharge opening from the supply container may also be identical with the dosing opening of the dosing element.

This type of disc spreader for agricultural purposes is known, for example, from DE 10 2007 053 550 A1, which is incorporated herein by reference, whereby the disc spreader is designed as a twin disc spreader having a supply container with at least two discharge openings that are laterally spaced apart from one another. One dosing element each, with one dosing opening each, is situated downstream from the respective discharge opening of the supply container, and one spreader disc each that is rotatable about a rotational axis is situated below each respective dosing opening.

In the case of winter road maintenance machines, the supply container is used primarily to accommodate generally granular grit and/or road salt, with the function of such a winter road maintenance machine largely corresponding to that of an agricultural spreading machine described above. Winter road maintenance machines may likewise have multiple or in particular two spreader discs, or also only one spreader disc, which are/is usually likewise provided with ejector vanes.

Twin disc spreaders are also known from DE 39 06 756 A1 or EP 0 380 040 B1, which are both incorporated herein by reference, in which one discharge shaft each extends downwardly in the direction of a respective spreader disc at the dosing opening of a respective dosing element, the discharge shaft enclosing the dosing opening around a portion of its circumference and being open at the bottom, so that the mass flow of distributed material, set by means of the dosing element, drops through the discharge shaft before it falls on the spreader disc therebeneath or against its ejector vane. While on the one hand such a discharge shaft can safeguard the falling distributed material from external influences such as wind effects in particular, on the other hand its purpose is to reduce so-called impact losses and quantity errors, which occur with generic disc spreaders, in particular for relatively high mass flows of distributed material or with high travel speeds and/or large working widths. Impact losses are understood in particular to mean overfertilization that occurs in the central area of the lateral distribution of distributed material on the ground, which is caused when distributed material particles, which are not captured by the ejector vanes of the spreader disc in a controlled manner, upon entering the ejector vane in the falling distributed material jet are accelerated or deflected in any given direction due to impact processes. In contrast, the so-called quantity effect, which also cannot be eliminated by the customary travel along two parallel tracks on the field, arises from different loadings of the ejector vanes of the spreader discs with distributed material for various mass flows. For low mass flows, individual distributed material particles are accelerated outwardly at high speed, and therefore reach the end of the ejector vane earlier, i.e., are ejected earlier (more is distributed in the center), whereas with increasing mass flow the ejector vane “fills up” with distributed material, so that the distributed material aggregate slides outwardly along the ejector vane more slowly and therefore is ejected later (more is distributed to the outside).

A particular drawback with known discharge shafts of disc spreaders is that external influences cannot be completely eliminated, and there is a continuing risk that the dosed distributed material flow is deflected laterally and not captured by the ejector vanes of the spreader disc as intended.

### SUMMARY OF THE INVENTION

It is therefore an object of the present invention to provide a disc spreader in a simple and cost-effective manner, so that distribution errors due to deflection of the dosed mass flow of distributed material impacting the spreader disc, resulting from unintentional shifting of the point of application, are minimized while at least largely avoiding the drawbacks mentioned above.

According to an example of the invention, this object is achieved by a disc spreader of the type mentioned at the outset, in that the discharge shaft at its free end facing the spreader disc extends essentially completely around the dosing opening, with the discharge shaft having at least one passage in the area of its end facing away from the spreader disc.

The example of the discharge shaft of the disc spreader according to the invention represents a refinement of known discharge shafts which is purely mechanical and which from a design standpoint is very simple and cost-effective, in which the discharge shafts always extend only around a partial circumference of the discharge opening of the supply container and/or of the dosing opening of the dosing element, in that according to the invention, the discharge shaft at its free (lower) end facing the spreader disc or facing away from the dosing opening of the dosing element (or from the discharge opening of the supply container) extends essentially completely around the dosing opening, so that a discharge shaft is formed that is completely closed at its free (lower) end facing the spreader disc, and external influences on the dosed distributed material flow falling from the dosing opening onto the spreader disc are essentially excluded. However, since a considerable suction effect may occur with such a “closed” discharge shaft due to the rotating spreader disc, depending on the rotational speed, which in turn may result in uncontrolled lateral deflection of the distributed material flow which specifically is to be avoided, the invention also provides at least one passage, used for pressure compensation, in a circumferential wall of the discharge shaft, the passage being situated in the area of the (upper) end of the discharge shaft facing away from the spreader disc or facing the dosing opening of the dosing element (or the discharge opening), where the dosed mass flow of distributed material falls out specifically from the discharge opening or from the dosing opening without the risk of lateral deflection and a resulting displacement of the point of application of the distributed material onto the spreader disc, as would be the case with free fall of the mass flow of distributed material close to the spreader disc or its ejector vanes, which applies in particular, although not exclusively, when the spreader disc rotates at a high rotational speed and thus brings about a relatively large suction effect. This avoids incorrect dosing due to deviations in the result of a calibration test (with the spreader disc at rest) from the dosed mass flow of distributed material (with the spreader disc rotating) during operation due to a suction effect, which is eliminated according to the invention, as well as errors in the spreading pattern due to uncontrolled lateral deflections of the mass flow of distributed material that impacts the spreader disc or its ejector vanes and falls through the discharge shaft.

While the dosing element can in principle have any known design, it may preferably have a dosing slide that cooperates with the dosing opening and in particular that is essentially vertical, i.e., swivelable about a swivel axis approximately parallel to the rotational axis of the spreader disc, and that is displaceable between a closed position in which it completely closes the dosing opening, and multiple opening positions in which it partially and/or completely frees up the dosing opening, as is the case for most commercially available disc spreaders.

In the area of its end facing away from the spreader disc, the discharge shaft according to the invention may in principle have only one, or in particular also a plurality of, passages, for example two or three passages, which may be advantageous with regard to greater mechanical stability of the discharge shaft and in particular with regard to a distribution of the pressure compensation for preventing a suction effect on a fairly wide surface area.

In order to provide reliable pressure compensation to prevent a suction effect while at the same time ensuring reliable protection of the dosed mass flow of distributed material from external effects, it has proven advantageous for the at least one passage to extend around a circumferential section of the discharge shaft for at least approximately 30°, in particular at least approximately 45°, preferably at least 60°, for example at least approximately 75°, and on the other hand, for the at least one passage to preferably extend around a circumferential section of the discharge shaft for at most approximately 180°, in particular at most approximately 150°, preferably at most approximately 120°, for example at most approximately 105°.

With regard to the total area of the at least one passage or the multiple passages of the discharge shaft, it has been found that the total area of the at least one passage should be at least approximately 5%, in particular at least approximately 8%, of the total circumferential surface of the discharge shaft, it generally being sufficient for the total area of the at least one passage to be at most approximately 25%, in particular at most approximately 20%, of the total circumferential surface of the discharge shaft.

To ensure the greatest possible protection of the mass flow of distributed material falling through the discharge shaft, according to an example, it may be provided that the discharge shaft extends from directly below the dosing element to directly above the spreader disc or its ejector vanes.

The discharge shaft at its free (lower) end facing the spreader disc or facing away from the dosing element can be provided with elastically flexible material strips such as bristles, bristle bundles, or the like, which extend at least around a circumferential section of the discharge shaft in the direction of the spreader disc, in particular essentially around the entire circumference of the discharge shaft.

In this case, the elastically flexible material strips preferably extend from the free (lower) end of the discharge shaft facing the spreader disc or facing away from the dosing element to directly above the spreader disc or its ejector vanes; such a design of the discharge shaft with downwardly protruding, in particular essentially completely protruding, elastically flexible material strips at its free end, also provides the option for the free ends of the material strips to reach to the free end of the ejector blades. The elastically flexible material strips of the discharge shaft may advantageously be made of an in particular wear-resistant plastic material.

The discharge shaft may preferably be made of a plastic material, which advantageously may be a plastic material based on thermoplastic polymers. On the one hand this facilitates recycling and thus increases environmental friendliness, and on the other hand, thermoplastic polymers in particular provide the option for the discharge shaft to be designed in the form of an injection-molded part or a 3D printed part.

As stated above, in other respects the disc spreader according to the invention may in particular be a twin disc spreader having a supply container with at least two discharge openings that are laterally spaced apart from one another, with one dosing element each that has one dosing opening each being situated downstream from a respective discharge opening, and with one spreader disc each which is rotatable about a rotational axis and is situated below a respective dosing opening, and with one discharge shaft each of the above-mentioned type extending downwardly from a particular dosing opening in the direction of the particular spreader disc, with the discharge shaft at its free (lower) end that faces the spreader disc or that faces away from the dosing element extending essentially completely around the dosing opening, with a respective discharge shaft having at least one passage in the area of its (upper) end facing away from the respective spreader disc or facing the dosing element.

In such a twin disc spreader, in which the spreader discs generally have opposite rotational directions, with the right spreader disc rotating counterclockwise viewed in the travel direction, and the left spreader disc rotating clockwise, likewise viewed in the travel direction, in an example it may be provided that the at least one passage is situated in a circumferential region of the discharge shaft that extends in a front and/or laterally outer circumferential section of the discharge shaft, viewed in the travel direction. This ensures that the at least one passage, viewed in the rotational or circumferential direction of a respective spreader disc, is situated downstream from the point of impact of the dosed mass flow of distributed material on the ejector blades of the spreader disc, so that for resulting pressure surges, reliable pressure compensation is provided by the at least one passage without lateral deflection of the mass flow of distributed material occurring, which would result in a displacement of the point of application.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic side view of an example of a disc spreader in the form of a twin disc spreader, designed as an agricultural attachment, which is accommodatable by the three-point hitch of a towing machine such as a tractor, viewed from the rear;

FIG. 2 shows a partially cutaway, schematic perspective top view of a base situated on the underside of one of the two container portions of the supply container of the disc spreader according to FIG. 1, together with a discharge opening;

FIG. 3 shows a schematic perspective detailed view of the base provided with the discharge opening corresponding to detail A in FIG. 2, including an agitator situated thereabove, and a dosing opening of a dosing element situated therebelow;

FIG. 4 shows a schematic perspective detailed view of one of the bottom portions of the supply container of the disc spreader according to FIG. 1, together with the discharge opening, the discharge shaft situated therebelow, and the spreader disc provided with ejector vanes, and with the dosing element omitted for reasons of clarity;

FIG. 5 shows a schematic perspective detailed view of the discharge shaft according to FIG. 4, viewed obliquely from above; and

FIG. 6 shows a schematic perspective detailed view of the discharge shaft according to FIGS. 4 and 5, viewed obliquely from below.

### DETAILED DESCRIPTION

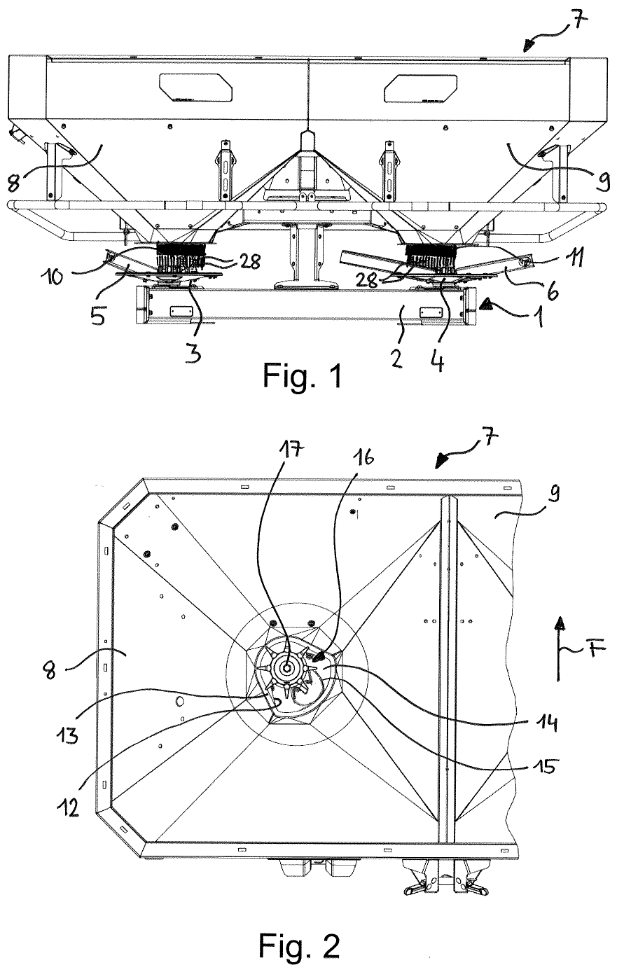

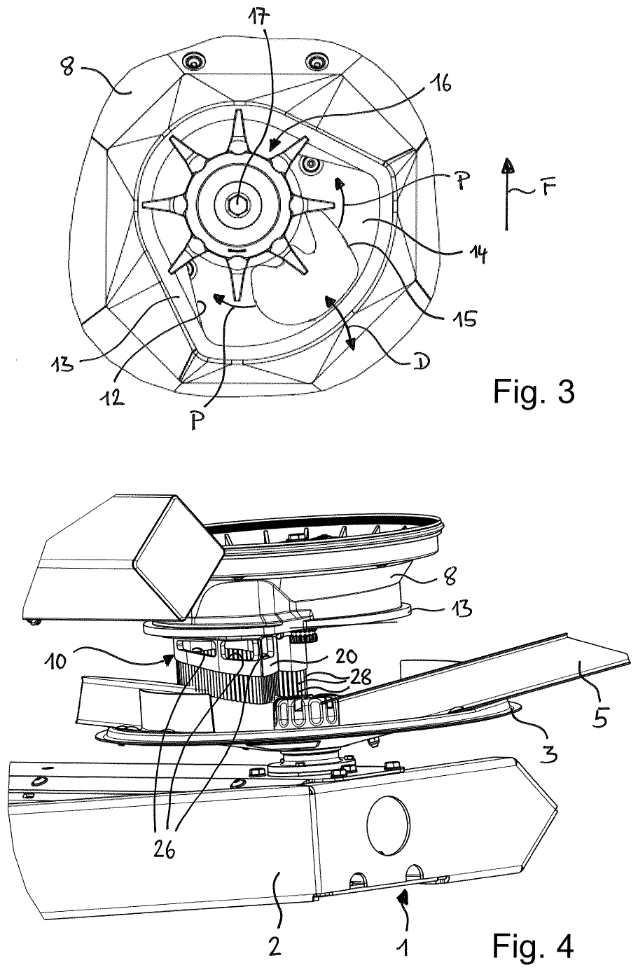

FIG. 1 shows an example of an example of a disc spreader or disc broadcaster according to the invention, in the present case designed as a twin disc spreader. The disc spreader has a frame 1 with a crossbar 2, which in the case, for example, of a mechanical drive of the spreader discs 3, 4, provided with ejector vanes or blades 5, 6, that is derived from the power take-off shaft of a towing machine such as a tractor, accommodates a transverse drive. In the case of a hydraulic or electric drive with controllable speed, the hydraulic or electric motors associated with each spreader disc 3, 4 are fastened to the crossbar 2. In this way, the spreader discs 3, 4 are generally set in rotation in opposite directions during operation, with the right spreader disc rotating counterclockwise, viewed in the travel direction F (see FIGS. 2 and 3), and the left spreader disc rotating clockwise, likewise viewed in the travel direction F, when the spreader discs 3, 4 are observed from above. The disc spreader also includes a supply container 7, which in the present case has two funnel-shaped container portions 8, 9, whose discharge opening (not visible in FIG. 1) is adjoined at the bottom by the dosing opening of a dosing element, in each case likewise not visible in FIG. 1. The dosing opening of a respective dosing element is likewise adjoined at the bottom by a discharge shaft 10, 11 in each case, which extends from directly below a respective dosing element to directly above a respective spreader disc 3, 4 or its ejector vanes 5, 6, and as explained in greater detail below with reference to FIGS. 4 through 6, encloses the entire circumference of the dosing opening, so that the distributed material dosed via a respective dosing element falls through the discharge shaft 10, 11, which is open at the bottom, onto the respective spreader disc 3, 4 and is captured by their ejector vanes 5, 6.

As is apparent in FIG. 2 and in particular FIG. 3, a discharge opening 12 is situated on the underside of each essentially funnel-shaped, downwardly tapering container portion 8, 9. In the present example, the discharge opening has an approximately ring-shaped design and is eccentrically situated in a base 13 surrounding same. Situated in each case below the approximately ring-shaped base 13 delimiting the discharge openings 12 of the supply container 7 is a dosing element having one dosing part 14 each which is approximately plate-shaped, for example, with a dosing opening 15, and which is moved back and forth via actuator, for example, by means of an apparatus for adjusting the point of application of the distributed material onto the spreader disc 3, 4. The free cross section of the dosing opening 15 is controllable by means of a dosing slide, which in particular is likewise activated via actuator, for setting the spread rate. The dosing slide is supported below the dosing opening 15 so that it is swivelable on a swivel axis that is vertical, i.e., parallel to the rotational axis of the spreader discs 3, 4, and the dosing slide is displaceable between a closed position in which it completely closes the dosing opening 15, and the open position, apparent in FIGS. 2 and 3, in which it completely frees up the dosing opening 15, as well as arbitrary intermediate positions in which it partially frees up the dosing opening 15, as indicated by the arrow D in FIG. 3.

As is further apparent from FIGS. 2 and 3, an agitator 16 situated directly above each base 13 is associated with the discharge opening 12 of each container portion 8, 9 of the supply container 7, with the vertical rotational axis 17 of the agitator coinciding with that of the spreader discs 3, 4, for example. The rotational axis 17 of the agitator 16 may be supported, for example, in the respective base 13 and rotationally driven by a controllable drive. The arrangement of the agitators 16 is selected in such a way that the space below the discharge opening 12 in the respective base 13 on the one hand and the associated spreader disc 3, 4 on the other hand remains open, so that the distributed material can pass through the discharge shaft 10, 11 (see FIG. 1) and onto the spreader disc 3, 4 without hindrance. In this way, the spreader discs 3, 4 (FIG. 1) with the ends of their ejector vanes 5, 6 eject the distributed material into a spread fan in each case, which results in a partially overlapping spreading pattern having a flat triangular shape. A linear distribution results from parallel tracking. The one spreader disc 3, 4 ejects the distributed material onto the other side to approximately one-half the working width, so that boundary spreading is also possible. However, the present invention may of course also be implemented in any other design of a single or twin disc spreader for agricultural or winter road maintenance purposes.

In addition, a retaining device, such as in the form of a screen, grate, grill, or the like, may advantageously be inserted into the lower area of the container bottom portion 8, 9, above a respective agitator 16, the retaining device being used to hold back foreign bodies such as rocks, clods of earth, and the like, as well as caked distributed material agglomerations, so that they cannot reach the dosing element or pass into the discharge shaft 10, 11, where they could result in clogging.

As stated above, below the discharge opening 12 formed in the base 13, the dosing part 14 (which in the present example has an approximately plate-shaped design) of a respective dosing element provided together with the dosing opening 15, which cooperates with the dosing slide in the manner of a diaphragm, is displaceable back and forth via actuator, for example, by means of the apparatus for adjusting the point of application, wherein in the present example, this back-and-forth movement of the plate-shaped dosing part 14 is a rotational movement about the axis 17, i.e., is coaxial with respect to the rotational axis of the agitator 16 and coaxial with respect to the rotational axis of a respective spreader disc 3, 4 (see the arrow P in FIG. 3) to allow adjustment of the point of application of the distributed material onto the spreader disc 3, 4 in the circumferential direction thereof. To displace the points of application, determined by the position of a particular dosing opening 15 of a particular dosing part 14, onto the spreader discs 3, 4, the dosing parts 14 may thus rotate about their center of rotation 17 by means of an apparatus in each case for displacing the point of application. The apparatus for displacing the point of application may be the one that is known from DE 10 2012 024 363 A1, which is incorporated herein by reference.

FIGS. 4 through 6 each show an example of the discharge shaft 10 in FIG. 1, with a detailed description of the other discharge shaft 11 being omitted due to its corresponding but mirror-symmetrical configuration. As is apparent from FIGS. 4 through 6, the discharge shaft 10 has a circumferential wall 20, which in the present case is essentially adapted to the circumference of the dosing opening 15, and with its end facing the spreader disc 3 (see FIG. 4) or facing away from the base 13 with the discharge opening 12 and the dosing part 14 with the dosing opening 15, extends completely around the dosing opening 15. The discharge shaft 10 may, for example, be detachably fastenable to the underside of the dosing part 14 that is provided with the dosing opening 15. For this purpose, in the example shown the discharge shaft 10 includes a fastening device 21 with, on the one hand, two spaced-apart, for example approximately U-shaped receptacles 22, 23 situated at carriers 24 laterally protruding from the side of the circumferential wall 20 of the discharge shaft 10 in order to detachably bring the receptacles 22, 23 into engagement, for example with complementary bolts on the underside of the dosing part 14 that is provided with the dosing opening 15. On the other hand, the fastening device 21 includes, for example, a fastening hole 25 which is separated by a lateral distance from the receptacles 22, 23, and which is used to accommodate a screw or the like to allow fastening of the discharge shaft 10 to the dosing part 14.

For the sake of completeness, it is noted at this point that the discharge shafts 10, 11 do not necessarily have to have a cross-sectional shape that is complementary to the dosing opening 15, and in principle may also be situated, for example, at the circumference of the discharge opening 12 (see FIGS. 2 and 3) when the latter coincides with the dosing opening 15. In particular when the disc spreader does not have an apparatus for displacing the point of application of the distributed material onto the spreader discs 3, 4, the discharge opening and the dosing opening may be the same opening at the base of the supply container 7 or of a respective container portion 8, 9.

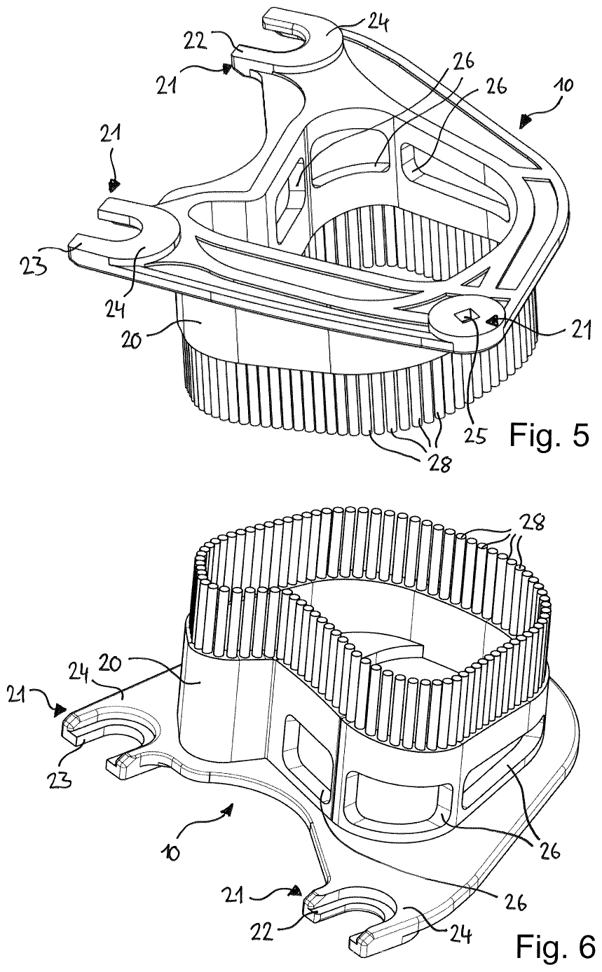

As is further apparent from FIGS. 5 and 6, but also from FIG. 4, the discharge shaft 10 in the area of its (upper) end facing away from the spreader disc 3 has at least one passage 26 (in the present case three passages 26) that is/are arranged in the circumferential wall 20 of the discharge shaft 10, for example next to one another in the circumferential direction at a height close to that of the fastening device 21, and used for pressure compensation to prevent a suction effect inside the completely closed discharge shaft 10 when the spreader disc 3 is rotated. Although the passages 26 in the illustrated example are primarily rectangular with rounded edges, they may of course also have practically any other geometric shape, for example round, oval, polygonal, etc.

At its free (lower) end facing the spreader disc 3, the discharge shaft 10 is also provided with elastically flexible material strips 28 such as bristles, bristle bundles, or the like, which likewise extend around the entire circumference of the discharge shaft 10 in the direction of the spreader disc 3 and in particular to directly above the spreader disc 3 or its ejector vanes 5. In the example shown, the elastically flexible material strips 28 all have approximately the same length, with their ends situated in particular in a horizontal plane directly above the spreader disc 3 provided with the ejector vanes 5. The elastically flexible material strips 28 may be made, for example, of an in particular wear-resistant plastic material, whereas the discharge shaft 10 with its circumferential wall 20 and the fastening device 21 is preferably made of a thermoplastic plastic material, and in particular may be designed in the form of an injection-molded part or a 3D printed part.

With regard to the passages 26 in the circumferential wall 20 of the discharge shaft 10, their total area is dimensioned in such a way, for example, that they constitute approximately 10% of the total circumferential surface of the discharge shaft 10, or more precisely, the circumferential wall 10 including the flexible elastic material strips 28, thus ensuring sufficient pressure compensation for preventing a suction effect. For similar reasons, the passages 26, in the present case three passages, extend around approximately one-fourth of the circumference of the circumferential wall 20 of the discharge shaft 10. In addition, it may be advantageous for the passages 26 to be situated in a circumferential area of the circumferential wall 20 of the discharge shaft 10 which extends in a front and/or laterally outer circumferential section of the discharge shaft 10, viewed in the travel direction F (see FIGS. 2 and 3), for example around a circumferential section of the discharge shaft 10 of approximately 90°, corresponding to one-fourth of the circumferential area of the circumferential wall 20, with this circumferential section extending with a radian measure of approximately 90° from the front side of the discharge shaft 10, viewed in the travel direction F, to its laterally outer side. This ensures that at least one of the passages 26, viewed in the rotational or circumferential direction of a particular spreader disc 10, is positioned downstream from the point of impact of the dosed mass flow of distributed material on the ejector blades 5 of the spreader disc 3, so that for pressure surges thus caused, satisfactory pressure compensation is provided by the passages 26 without lateral deflection of the mass flow of distributed material occurring, which would result in a displacement of the point of application.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A disc spreader for distributing distributed material, the disc spreader comprising:
a supply container to accommodate the distributed material;
at least one discharge opening;
at least one dosing element arranged downstream from the discharge opening of the supply container;
a dosing opening;
at least one spreader disc that is arranged below the dosing opening and rotatable about a rotational axis; and
a discharge shaft that encloses at least a circumferential section of the dosing opening and that extends downwardly from the dosing opening in a direction of the spreader disc, the discharge shaft at its free end faces the spreader disc and extends essentially completely around the dosing opening, the discharge shaft having at least one passage in an area of its end facing away from the spreader disc.

2. The disc spreader according to claim 1, wherein the dosing element has a dosing slide that cooperates with the dosing opening and that is swivelable about an essentially vertical swivel axis, and that is displaceable between a closed position in which it completely closes the dosing opening, and multiple opening positions in which it partially and/or completely frees up the dosing opening.

3. The disc spreader according to claim 1, wherein in the area of its end facing away from the spreader disc, the discharge shaft has a plurality of passages or two or three passages.

4. The disc spreader according to claim 1, wherein the at least one passage extends around a circumferential section of the discharge shaft for at least approximately 30°, or at least approximately 45°, or at least 60°, and/or at most 180°, or at most 150°, or at most 120°.

5. The disc spreader according to claim 1, wherein a total area of the at least one passage of the discharge shaft is at least 5%, in particular at least 8%, and/or at most approximately 25%, or at most 20%, of the total circumferential surface of the discharge shaft (10, 11).

6. The disc spreader according to claim 1, wherein the discharge shaft extends from directly below the dosing element to directly above the spreader disc or its ejector vanes.

7. The disc spreader according to claim 1, wherein the discharge shaft at its free end facing the spreader disc is provided with elastically flexible material strips or bristles or bristle bundles, which extend at least around a circumferential section of the discharge shaft in the direction of the spreader disc.

8. The disc spreader according to claim 7, wherein the elastically flexible material strips extend essentially around the entire circumference of the discharge shaft.

9. The disc spreader according to claim 7, wherein the elastically flexible material strips extend from the free end of the discharge shaft facing the spreader disc to directly above the spreader disc or its ejector vanes.

10. The disc spreader according to claim 7, wherein the elastically flexible material strips are made of a wear-resistant plastic material.

11. The disc spreader according to claim 1, wherein the discharge shaft is made of a plastic material.

12. The disc spreader according to claim 11, wherein the plastic material of the discharge shaft is a plastic material based on thermoplastic polymers, and wherein the discharge shaft is designed in the form of an injection-molded part or a 3D printed part.

13. The disc spreader according to claim 1, wherein the disc spreader is a twin disc spreader having a supply container with at least two discharge openings that are laterally spaced apart from one another, with one dosing element each that has one dosing opening being situated downstream from a respective discharge opening of the supply container, and with one spreader disc each which is rotatable about a rotational axis and is situated below a respective dosing opening, and with one discharge shaft each extending downwardly from a particular dosing opening in the direction of the particular spreader disc, with the discharge shaft at its free end that faces the spreader disc extending essentially completely around the dosing opening, with a respective discharge shaft having at least one passage in the area of its end facing away from the respective spreader disc.

14. The disc spreader according to claim 13, wherein the at least one passage is situated in a circumferential region of the discharge shaft that extends in a front and/or laterally outer circumferential section of the discharge shaft viewed in a travel direction.
